(19) United States
(12) Patent Application Publication
(10) Pub. No.: US 2012/0052342 A1
(43) Pub. Date: Mar. 1, 2012

(54) ENERGY STORAGE CHAMBERS WITH FLEXIBLE PACKAGES, DEVICES AND SYSTEMS USING THE SAME, AND METHOD FOR FABRICATING THE SAME

(75) Inventor: Hsiao-Wen HUANG, Taoyuan Hsien (TW)

(73) Assignee: Delta Electronics, Inc.

(21) Appl. No.: 13/215,845

(22) Filed: Aug. 23, 2011

Related U.S. Application Data
(60) Provisional application No. 61/376,521, filed on Aug. 24, 2010.

(51) Int. Cl. H01M 2/12; H01G 9/145; H01G 9/155; H01M 10/04

(52) U.S. Cl. 429/53; 29/623.1; 29/25.03; 361/502

(57) ABSTRACT

An energy storage device is provided. In one embodiment, the energy storage device includes an energy storage chamber containing an electrolyte, a flexible package packaging the energy storage chamber, a set of electrodes contacting with the electrolyte and extending from the interior of the energy storage chamber to the exterior of the flexible package for electrical connection, a first pipe extending from the interior of the energy storage chamber to the exterior of the flexible package, and a second pipe extending from the interior of the energy storage chamber to the exterior of the flexible package, and the electrolyte is conducted to the interior of the energy storage chamber through the first pipe, and the electrolyte and gas produced inside the energy storage chamber are exhausted through the second pipe. A system and a fabricating method are also provided.

### CROSS REFERENCE TO RELATED APPLICATIONS

This application claims the benefit of U.S. Provisional Application No. 61/376,521, filed Aug. 24, 2010, the entirety of which is incorporated by reference herein.

### BACKGROUND OF THE INVENTION

1. Field of the Invention

The invention relates to an energy storage chamber, and more particularly to a device and a system includes energy storage chambers with flexible packages, and fabrication method thereof.

2. Description of the Related Art

For an energy storage chamber, when an activation process is performed thereon, the effective contact area with electrolytes and conductivity of electrodes are increased. However, incorporated herein by references U.S. Pat. No. 5,474,858 and U.S. Pat. No. 7,436,651, some unexpected gas is simultaneously produced during the activation process is performed. For an inflexible package of an energy storage chamber, a high compressive strength is used to prevent deformation thereof due to the activation process. Meanwhile, for a flexible package of an energy storage chamber, a low compressive strength can not prevent deformation thereof due to the activation process; thus, practicability and production yields for flexible packages of energy storage chambers are lower than that of inflexible packages of energy storage chambers.

### BRIEF SUMMARY OF THE INVENTION

One embodiment of the invention provides an energy storage device comprising an energy storage chamber containing an electrolyte, a flexible package packaging the energy storage chamber, a set of electrodes contacting with the electrolyte and extending from an interior of the energy storage chamber to an exterior of the flexible package for electrical connection, two pipes extending from the interior of the energy storage chamber to the exterior of the flexible package, wherein the electrolyte is conducted to the interior of the energy storage chamber through one of the two pipes, and wherein the electrolyte and gas produced inside the energy storage chamber are exhausted through the other of the two pipes.

One embodiment of the invention provides a method for fabricating an energy storage device comprising steps of providing the disclosed energy storage chamber with the flexible package, conducting the electrolyte to the interior of the energy storage chamber through the one of the two pipes, performing an activation process on the energy storage chamber, and exhausting the electrolyte and the gas produced inside the energy storage chamber through the other of the two pipes.

One embodiment of the invention provides an energy storage system comprising a plurality of energy storage devices containing an electrolyte and at least a first terminal energy storage chamber and a second terminal energy storage chamber, wherein each energy storage chamber is packaged by a flexible package and two adjacent energy storage devices are connected with a connecting pipe, a first pipe extending from an interior of the first terminal energy storage chamber to an exterior of the flexible package of the first terminal energy storage chamber, and a second pipe extending from an interior of the second terminal energy storage chamber to an exterior of the flexible package of the second terminal energy storage chamber, and the electrolyte is conducted to the interior of the first terminal energy storage chamber through the first pipe, and then runs through each chamber with the connecting pipes. Finally, the electrolyte and gas produced inside the energy storage chambers are exhausted through the second pipe. The energy storage system of the present invention is reduced in deformation of flexible package due to gas formation, and the potential and temperature of each device could be balanced.

One embodiment of the invention provides an energy storage system comprising a plurality of energy storage devices containing an electrolyte and an energy storage chamber, wherein each energy storage chamber is packaged by a flexible package, a first pipe group having a plurality of pipes, wherein each pipe of the first pipe group is respectively extended from an interior of one of the energy storage chambers to an exterior of the flexible package of the energy storage chamber, and the electrolyte is conducted to the interior of each of the energy storage chambers through the first pipe group, and a second pipe group having a plurality of pipes, wherein each pipe of the second pipe group is respectively extended from an interior of one of the energy storage chambers to an exterior of the flexible package of the energy storage chamber, and the electrolyte and gas produced inside the energy storage chambers are exhausted through the second pipe group. The energy storage system of the present invention is reduced in deformation of flexible package due to gas formation, and the potential and temperature of each device could be balanced.

In the invention, during the activation process, the electrolyte is continuously conducted into the energy storage chamber and exhausted therefrom to simultaneously carry out the gas produced from the activation process, preventing expansive deformation caused by gas accumulation, increasing yields. Additionally, by way of the same manner, the multiple energy storage devices are connected for activation simultaneously, simplifying the device fabrication process.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A shows an energy storage chamber with a flexible package according to one embodiment of the invention;

FIG. 1B shows a set of electrodes shown in FIG. 1A in more details;

FIG. 2 shows an energy storage chamber with a flexible package according to one embodiment of the invention;

FIG. 3 shows an energy storage chamber with a flexible package according to one embodiment of the invention;

FIG. 4 shows an energy storage system according to one embodiment of the invention;

FIG. 5 shows an energy storage system according to one embodiment of the invention; and

FIG. 6 shows an energy storage system according to one embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

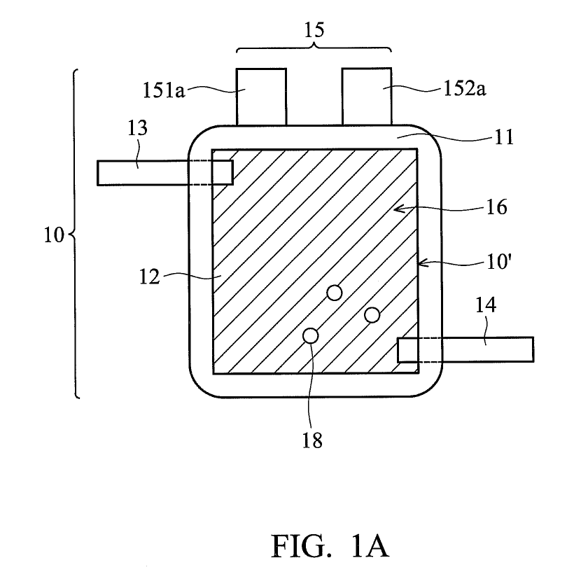

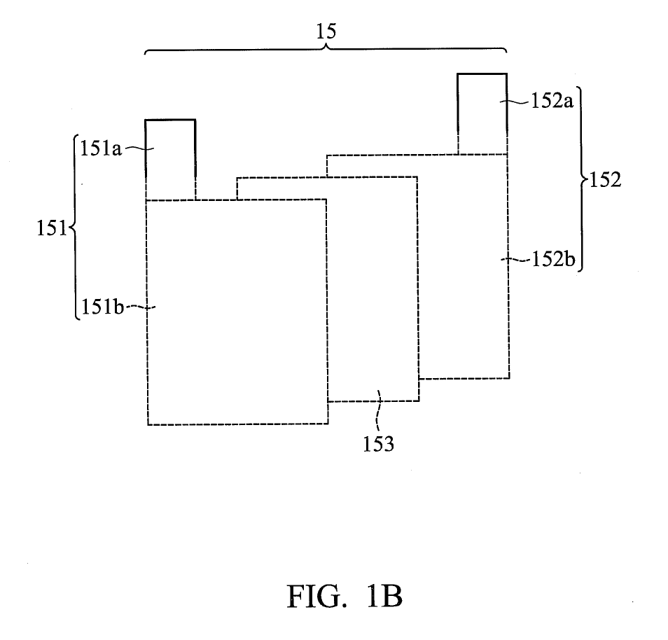

In one embodiment, an energy storage chamber with a flexible package is provided, as shown in FIG. 1A. An energy storage device 10 comprises an energy storage chamber 10′ containing an electrolyte 12, a flexible package 11 packaging the energy storage chamber 10′, a set of electrodes 15 contacting with the electrolyte 12 and extending from an interior 16 of the energy storage chamber 10′ to an exterior of the flexible package 11 for electrical connection(s), a first pipe 13 extending from the interior 16 of the energy storage chamber 10′ to the exterior of the flexible package 11, and a second pipe 14 extending from the interior 16 of the energy storage chamber 10′ to the exterior of the flexible package 11. The electrolyte 12 is conducted to the interior 16 of the energy storage chamber 10′ through the first pipe 13. The electrolyte 12 and gas 18 which is produced inside the energy storage chamber 10′ are exhausted through the second pipe 14. The term “exhaust” here and after through this disclosure means, for example, the gas are discharged to environment or where outside the energy storage device 10 by many possible ways, but will not limit the invention.

The energy storage chamber 10′ may be applied to electric double layer capacitors, pseudocapacitors, supercapacitors or batteries. The set of electrodes 15 is shown in FIG. 1B in more details, wherein the set of electrodes 15 may comprise a positive electrode 151 and a negative electrode 152. The positive electrode 151 comprises a positive exterior electrode 151a which extends from the interior 16 of the energy storage chamber 10′ to the exterior of the flexible package 11, and a positive interior electrode 151b which connects to the positive exterior electrode 151a and contacts with the electrolyte 12. The negative electrode 152 comprises a positive exterior electrode 152a which extends from the interior 16 of the energy storage chamber 10′ to the exterior of the flexible package 11, and a negative interior electrode 152b which connects to the negative exterior electrode 152a and contacts with the electrolyte 12, wherein the positive electrode 151 and the negative electrode 152 may not contacted with each other or separated by a separator 153. The active material of the electrodes 151 and 152 may comprise metal oxide, metal hydroxides, such as nickel oxide (NiO), nickel hydroxide (Ni(OH)₂), or nickel cobalt hydroxide (NiCo(OH)₂), or carbonaceous material, such as activated carbon, carbon fiber, graphite, or carbon fabric.

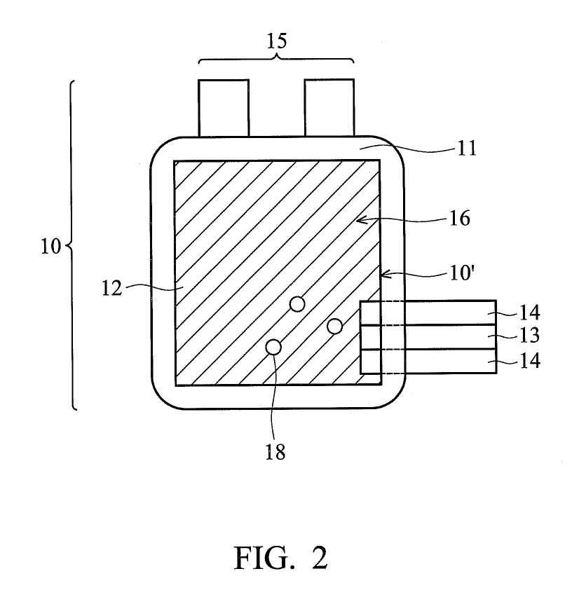

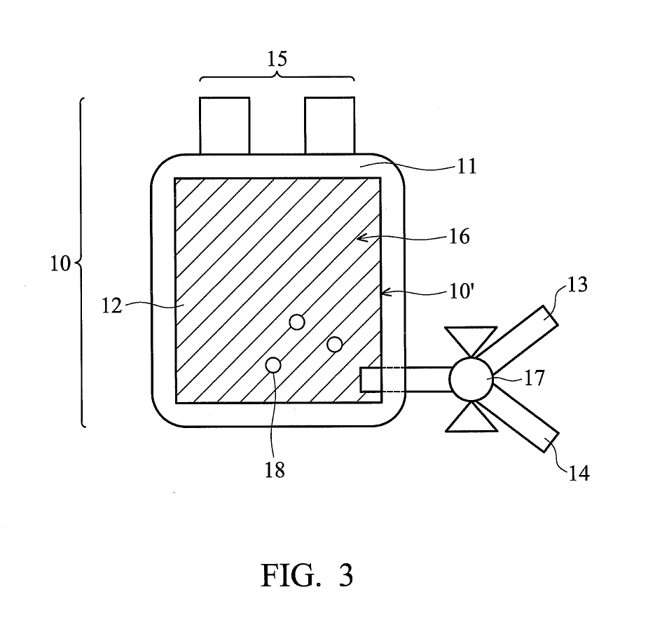

The first pipe 13 and the second pipe 14 may be concentric, as shown in FIG. 2. The first pipe 13 and the second pipe 14 may be connected with a valve 17, as shown in FIG. 3. The electrolyte 12 and the gas 18 produced inside the energy storage chamber 10′ are exhausted by, for example, a pressure drop. The pressure drop is resulted from, for example, gravity (as shown in FIG. 1) or using a pump (not shown) connected with the first pipe 13 and/or the second pipe 14. The energy storage device 10 may further comprise a cyclic system (not shown) connected with the first pipe 13 and the second pipe 14 at both terminals of the cyclic system to conduct the electrolyte 12 or an inert gas across the energy storage chamber 10′.

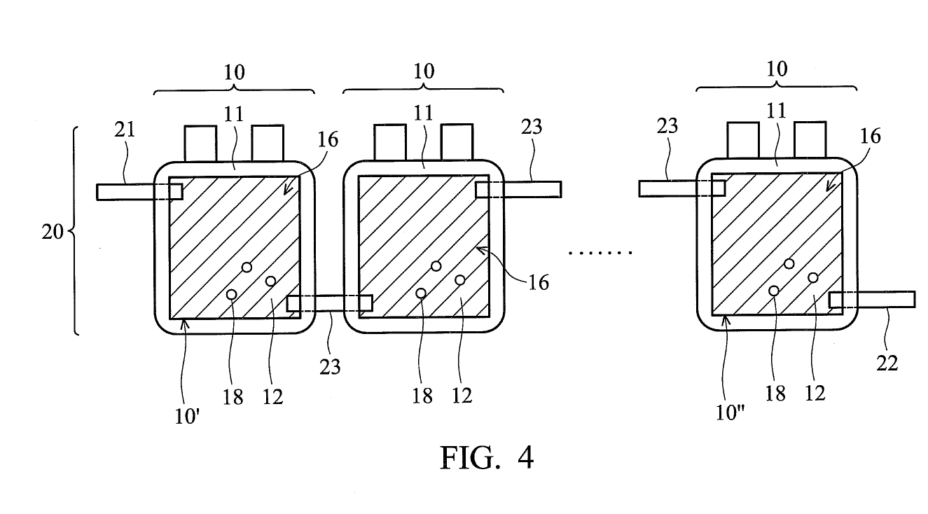

In one embodiment, an energy storage system is provided, as shown in FIG. 4. The energy storage system 20 comprise a plurality of energy storage devices 10 containing an electrolyte 12 and having at least a first terminal energy storage chamber 10′ and a second terminal energy storage chamber 10″, wherein each energy storage chamber (10′, 10″) is packaged by a flexible package 11 and two adjacent energy storage devices are connected with a connecting pipe 23. It is noted that with a plurality of the connecting pipes 23 as shown in FIG. 4, more energy storage devices as disclosed can be connected one by one and thus exchange electrolyte 12 and gas 18 as disclosed. A first pipe 21 extends from an interior 16 of the first terminal energy storage chamber 10′ to an exterior of the flexible package 11 of the first terminal energy storage chamber 10′, and a second pipe 22 extending from an interior 16 of the second terminal energy storage chamber 10″ to an exterior of the flexible package 11 of the second terminal energy storage chamber 10″. The electrolyte 12 is conducted to the interior 16 of the first terminal energy storage chamber 10′ through the first pipe 21. The electrolyte 12 and gas 18 produced inside the energy storage chambers (10′, 10″) are exhausted through the second pipe 22.

The electrolyte 12 is conducted to the interior 16 of the first terminal energy storage chamber 10′ through the first pipe 21, then runs through each energy storage chamber through the connecting pipes 23, and finally the electrolyte 12 and gas 18 produced inside the energy storage chambers (10′, 10″) are exhausted through the second pipe 22.

The energy storage chambers (10′, 10″) in this embodiment may be applied to electric double layer capacitors, pseudocapacitors, supercapacitors or batteries. The electrolyte 12 and the gas 18 produced inside the energy storage chambers (10′, 10″) are exhausted by, for example, a pressure drop. The pressure drop is resulted from, for example, gravity (as shown in FIG. 4) or using a pump (not shown) connected with the first pipe 21 or the second pipe 22. The energy storage system 20 may be disposed in a fixture (not shown) to facilitate gas to discharge by the limited space. The energy storage system 20 may further comprise a cyclic system (not shown) connected with the first pipe 21 and the second pipe 22 to conduct the electrolyte 12 or an inert gas across the energy storage chambers (10′, 10″).

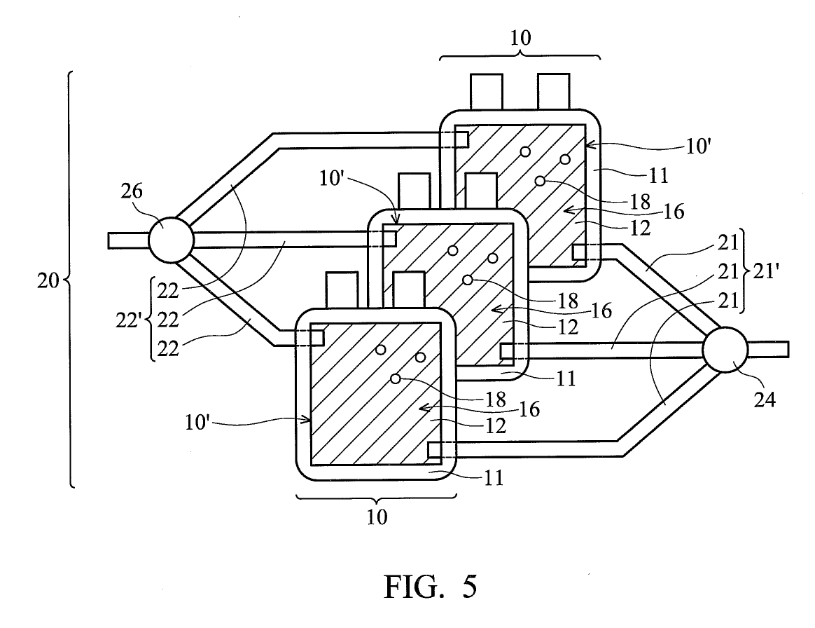

In one embodiment, an energy storage system is provided, as shown in FIG. 5. An energy storage system 20 comprises a plurality of energy storage devices 10 containing an electrolyte 12 and an energy storage chamber 10′, wherein each energy storage chamber 10′ of the energy storage device 10 is packaged by a flexible package 11. A first pipe group 21′ has a plurality of pipes 21 connected with a first valve 24. Specifically, each pipe 21 of the first pipe group 21′ respectively extends from an interior 16 of one energy storage chamber 10′ of the energy storage device 10 to an exterior of the flexible package 11 of the one energy storage chamber 10′. A second pipe group 22′ has a plurality of pipes 22 connected with a second valve 26. Specifically, each pipe 22 of the second pipe group 22′ respectively extends from an interior 16 of one energy storage chamber 10′ of the energy storage device 10 to an exterior of the flexible package 11 of the one energy storage chamber 10′. The electrolyte 12 is conducted to the interior 16 of the energy storage chambers 10′ of the energy storage devices 10 through the first valve 24 and the first pipe group 21′. The electrolyte 12 and gas 18 produced inside the energy storage chambers 10′ are exhausted through the second valve 26 and the second pipe group 22′.

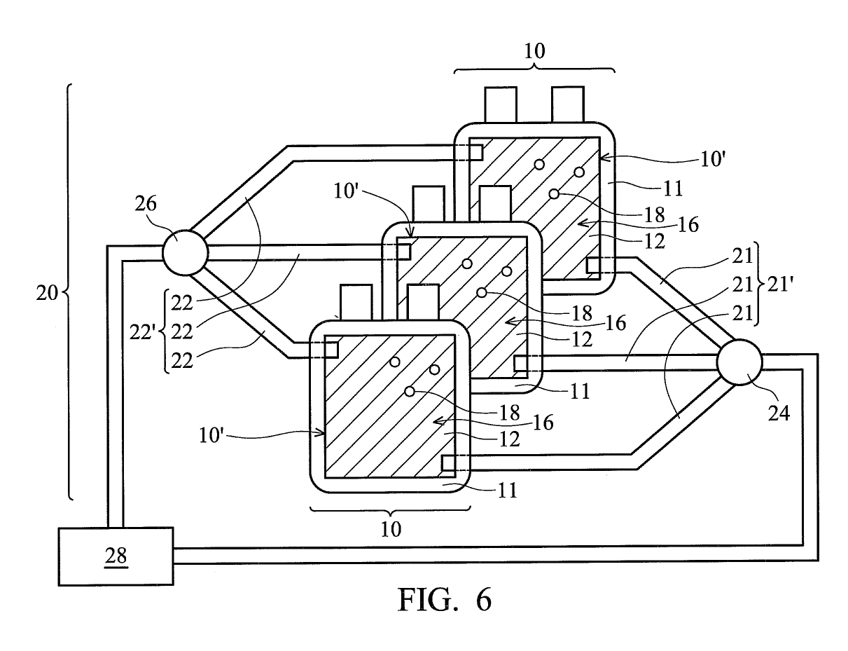

The energy storage device 10 in this embodiment may be applied to electric double layer capacitors, pseudocapacitors, supercapacitors or batteries. The electrolyte 12 and the gas 18 produced inside the energy storage chambers 10′ are exhausted by, for example, a pressure drop. The pressure drop is resulted from, for example, gravity (as shown in FIG. 5) or using a pump (not shown) connected with the first pipe group 21′ or the second pipe group 22′. The energy storage system 20 may be disposed in a fixture (not shown) to facilitate gas to discharge by the limited space. The energy storage system 20 may further comprise a cyclic system 28 connected with the first valve 24, the first pipe group 21′, the second pipe group 22′ and the second valve 26 to conduct the electrolyte 12 or an inert gas across the energy storage devices 10, as shown in FIG. 6.

One embodiment of the invention provides a method for fabricating an energy storage device, comprising the following steps. An energy storage device includes an energy storage chamber with a flexible package as shown in FIG. 1 is provided. Referring to FIG. 1, the energy storage device 10 comprises an energy storage chamber 10′ containing an electrolyte 12, a flexible package 11 packaging the energy storage chamber 10′, a set of electrodes 15 contacting with the electrolyte 12 and extending from an interior 16 of the energy storage chamber 10′ to an exterior of the flexible package 11 for electrical connection(s), a first pipe 13 extending from the interior 16 of the energy storage chamber 10′ to the exterior of the flexible package 11, and a second pipe 14 extending from the interior 16 of the energy storage chamber 10′ to the exterior of the flexible package 11. Next, electrolyte 12 is conducted to the interior 16 of the energy storage chamber 10′ through the first pipe 13. Next, an activation process is performed on the energy storage chamber 10′. The electrolyte 12 and gas 18 produced inside the energy storage chamber 10′ are exhausted through the second pipe 14.

The gas 18 may be produced from the activation process. The electrolyte 12 and the gas 18 produced inside the energy storage chamber are exhausted by, for example, a pressure drop. The pressure drop is resulted from, for example, gravity (as shown in FIG. 1) or using a pump (not shown) connected with the first pipe 13 or the second pipe 14. The disclosed method may further comprise a step of connecting a cyclic system (not shown) with the first pipe 13 and the second pipe 14 to conduct the electrolyte 12 or an inert gas across the energy storage chamber 10′.

In the invention, during the activation process, the electrolyte is continuously conducted into the energy storage chamber and discharged therefrom to simultaneously carry out the gas produced from the activation process, preventing expansive deformation caused by gas accumulation, increasing yields. Additionally, by way of the same manner, the multiple energy storage devices are connected simultaneously and serially for activation, simplifying device fabrication process.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An energy storage device, comprising:
an energy storage chamber containing an electrolyte;
a flexible package packaging the energy storage chamber;
a set of electrodes contacting with the electrolyte and extending from an interior of the energy storage chamber to an exterior of the flexible package for electrical connection; and
two pipes extending from the interior of the energy storage chamber to the exterior of the flexible package, wherein the electrolyte is conducted to the interior of the energy storage chamber through one of the two pipes, and wherein the electrolyte and gas produced inside the energy storage chamber are exhausted through the other of the two pipes.

2. The energy storage device as claimed in claim 1, wherein the energy storage device is applied to electric double layer capacitors, pseudocapacitors, supercapacitors or batteries.

3. The energy storage device as claimed in claim 1, wherein the two pipes are concentric.

4. The energy storage device as claimed in claim 1, wherein the two pipes are connected with a valve.

5. The energy storage device as claimed in claim 1, wherein the electrolyte and the gas produced inside the energy storage chamber are exhausted by a pressure drop.

6. The energy storage device as claimed in claim 5, wherein the pressure drop is resulted from gravity.

7. The energy storage device as claimed in claim 5, wherein the pressure drop is generated by using a pump connected with the two pipes.

8. The energy storage device as claimed in claim 1, further comprising a cyclic system connected with the two pipes to conduct the electrolyte or inert gas across the energy storage chamber.

9. The energy storage device as claimed in claim 1, wherein the set of electrodes comprises a first electrode comprising a first exterior electrode extending from the interior of the energy storage chamber to the exterior of the flexible package and a first interior electrode connecting to the first exterior electrode and contacting with the electrolyte, and a second electrode comprising a second exterior electrode extending from the interior of the energy storage chamber to the exterior of the flexible package and a second interior electrode connecting to the second exterior electrode and contacting with the electrolyte, wherein the first interior electrode and the second interior electrode are not contacted with each other.

10. An energy storage system, comprising:
a plurality of energy storage devices containing an electrolyte and at least a first terminal energy storage chamber and a second terminal energy storage chamber, wherein each energy storage chamber is packaged by a flexible package and two adjacent energy storage devices are connected with a connecting pipe;
a first pipe extending from an interior of the first terminal energy storage chamber to an exterior of the flexible package of the first terminal energy storage chamber, wherein the electrolyte is conducted to the interior of the first terminal energy storage chamber through the first pipe; and
a second pipe extending from an interior of the second terminal energy storage chamber to an exterior of the flexible package of the second terminal energy storage chamber, wherein the electrolyte and gas produced inside the energy storage chambers are exhausted through the second pipe.

11. The energy storage system as claimed in claim 10, wherein the energy storage device is applied to electric double layer capacitors, pseudocapacitors, supercapacitors or batteries.

12. The energy storage system as claimed in claim 10, wherein the electrolyte and the gas produced inside the energy storage chambers are exhausted by a pressure drop.

13. The energy storage system as claimed in claim 12, wherein the pressure drop is resulted from gravity.

14. The energy storage system as claimed in claim 12, wherein the pressure drop is generated by using a pump connected with the first pipe or the second pipe.

15. The energy storage system as claimed in claim 10, wherein the multiple energy storage chambers with flexible packages are disposed in a fixture.

16. The energy storage system as claimed in claim 10, further comprising a cyclic system connected with the first pipe and the second pipe to conduct the electrolyte or inert gas across the energy storage chambers.

17. A method for fabricating an energy storage device, comprising steps of:
providing an energy storage chamber with a flexible package as claimed in claim 1;
conducting the electrolyte to the interior of the energy storage chamber through the one of the two pipes;
performing an activation process on the energy storage chamber; and
exhausting the electrolyte and the gas produced inside the energy storage chamber through the other of the two pipes.

18. The method for fabricating an energy storage device as claimed in claim 17, wherein the gas is produced from the activation process.

19. The method for fabricating an energy storage device as claimed in claim 17, wherein the electrolyte and the gas produced inside the energy storage chamber are exhausted by a pressure drop.

20. The method for fabricating an energy storage device as claimed in claim 19, wherein the pressure drop is resulted from gravity.

21. The method for fabricating an energy storage device as claimed in claim 19, wherein the pressure drop is generated by using a pump connected with the two pipes.

22. The method for fabricating an energy storage device as claimed in claim 17, further comprising a step of connecting a cyclic system with the two pipes to conduct the electrolyte or inert gas across the energy storage chamber.

23. An energy storage system, comprising:
a plurality of energy storage devices containing an electrolyte and an energy storage chamber, wherein each energy storage chamber is packaged by a flexible package;
a first pipe group having a plurality of pipes, wherein each pipe of the first pipe group is respectively extended from an interior of one of the energy storage chambers to an exterior of the flexible package of the energy storage chamber, and the electrolyte is conducted to the interior of each of the energy storage chambers through the first pipe group; and
a second pipe group having a plurality of pipes, wherein each pipe of the second pipe group is respectively extended from an interior of one of the energy storage chambers to an exterior of the flexible package of the energy storage chamber, and the electrolyte and gas produced inside the energy storage chambers are exhausted through the second pipe group.

24. The energy storage system as claimed in claim 23, wherein the first pipe group is connected with a first valve, and the second pipe group is connected with a second valve.

25. The energy storage system as claimed in claim 24, wherein the electrolyte is conducted to the interior of the energy storage chambers through the first valve and the first pipe group, and then the electrolyte and the gas produced inside the energy storage chambers are exhausted through the second valve and the second pipe group.

26. The energy storage system as claimed in claim 24, further comprising a cyclic system connected with the first valve, the first pipe group, the second pipe group and the second valve to conduct the electrolyte or inert gas across the energy storage chambers.
